(19) United States
(12) Patent Application Publication
(10) Pub. No.: US 2021/0266025 A1
(43) Pub. Date: Aug. 26, 2021

(54) DATA COMMUNICATION TRANSCEIVER ASSEMBLY AND METHOD FOR INTEGRATION INTO ENTRANCE PORTS FOR UNDERGROUND ENCLOSURES

(71) Applicant: 3M INNOVATIVE PROPERTIES COMPANY, St Paul, MN (US)

(72) Inventors: Ernesto M. Rodriguez, Georgetown, TX (US); Steven E. Turch, Blaine, MN (US)

(21) Appl. No.: 17/250,413

(22) PCT Filed: Aug. 6, 2019
(86) PCT No.: PCT/IB2019/056693

§ 371 Date: Jan. 19, 2021

Related U.S. Application Data
(60) Provisional application No. 62/721,030, filed on Aug. 22, 2018.

(51) Int. Cl. H04B 1/38; H04Q 9/00

(52) U.S. Cl. CPC H04B 1/38; H04Q 2209/80; H04Q 2209/40; H04Q 9/00

(57) ABSTRACT

A data communication system for an enclosure comprises a transceiver mountable to a mounting location formed in an entrance port cover for the enclosure, the transceiver connectable to a sensor analytics unit disposed within the enclosure. The transceiver includes a housing having a cover portion with inwardly tapered sidewalls receivable in the mounting location, wherein the mounting location includes a hole having correspondingly tapered sidewalls. A top surface of the transceiver is configured to be positioned substantially flush to an upper surface of the entrance port cover when the transceiver is placed in an installed position. The transceiver is configured to communicate with a network outside of the enclosure.

### BACKGROUND

Machine to machine communication is becoming increasingly important to the energy, communications, and security markets, among others. Supervisory Control and Data Acquisition (SCADA) systems used in those industries rely on inputs from remotely located sensors to function properly. SCADA systems can also output signals to actuate remote equipment in the field. A sizeable portion of that equipment (˜18% for U.S. electric utilities) is located underground, and providing wireless communications between above ground and underground equipment is a serious challenge.

Current methods used to locate underground cable faults are still slow and labor intensive. Even relatively short outages can be used against utilities and lead to rate adjustments for customers, so a faster means of locating and fixing underground faults is needed.

Thus, there is a need for accessing and communicating wireless signals into and out of underground equipment vaults and other structures where the underground equipment is located.

### SUMMARY OF THE INVENTION

In one aspect of the invention, a data communication system for an enclosure comprises a transceiver mountable to a mounting location formed in an entrance port cover for the enclosure, the transceiver connectable to a sensor analytics unit disposed within the enclosure. The transceiver includes a housing having a cover portion with inwardly tapered sidewalls receivable in the mounting location, wherein the mounting location includes a hole having correspondingly tapered sidewalls. A top surface of the transceiver is configured to be positioned substantially flush to an upper surface of the entrance port cover when the transceiver is placed in an installed position. The transceiver is configured to communicate with a network outside of the enclosure.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The invention will be described hereinafter in part by reference to non-limiting examples thereof and with reference to the drawings, in which:

FIG. 1A is a partial isometric view of a data communication system including a transceiver mounted in an entrance port cover that is disposed on an entrance port according to a first aspect of the invention.

FIG. 1B is a partial isometric view of a data communication system including a transceiver mounted in an entrance port cover that is removed from an entrance port according to another aspect of the invention.

FIG. 2A is a close up partial exploded view of a transceiver and mounting location of an entrance port cover according to another aspect of the invention.

FIG. 2B is a close up partial exploded bottom view of a transceiver and mounting location of an entrance port cover according to another aspect of the invention.

FIG. 2C is a close up partial view of a transceiver installed in a mounting location of an entrance port cover according to another aspect of the invention.

FIG. 2D is a close up partial bottom view of a transceiver installed in a mounting location of an entrance port cover according to another aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

A transceiver for a data communication system for an enclosure, such as an underground enclosure or vault, is described herein. The transceiver is designed to be mounted to an entrance port cover, such as a manhole cover, in flush manner such that a top surface of the transceiver housing is substantially flush with a top surface of the entrance port cover. The transceiver housing includes a tapered outer surface design allowing it to be mounted to the entrance port cover from the top surface in a top down manner, as opposed to inserting the transceiver housing from below. The transceiver housing can be sealed (meeting IP68 requirements) and formed from a material that is transmissive to radio waves and is robust to handle harsh environmental conditions.

The transceiver can be connected to a sensor analytics unit (SAU), or to one or more sensors of the data communication system, disposed in the enclosure which provide data related to a condition of the enclosure or to components located therein. The transceiver housing design allows for straightforward installation and protection of the connections from the SAU and/or the sensor(s) disposed within the enclosure or vault.

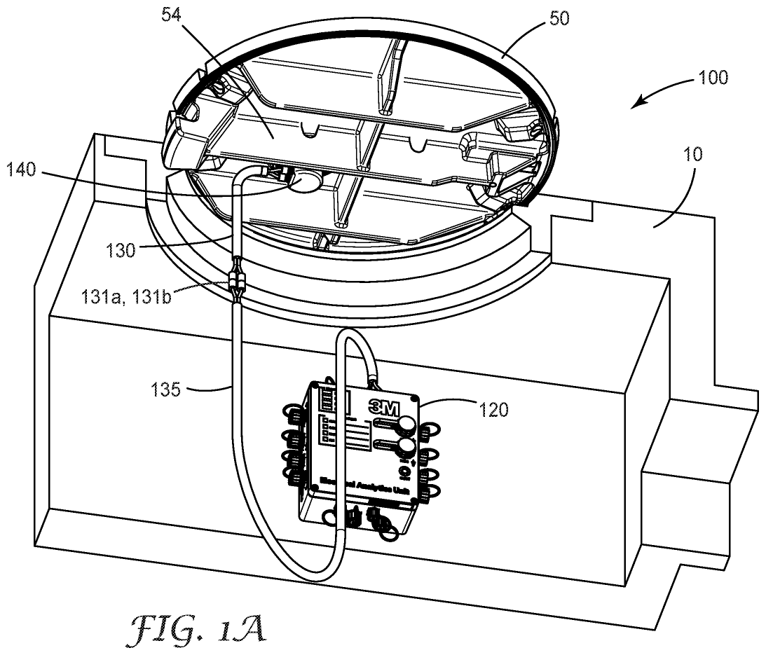

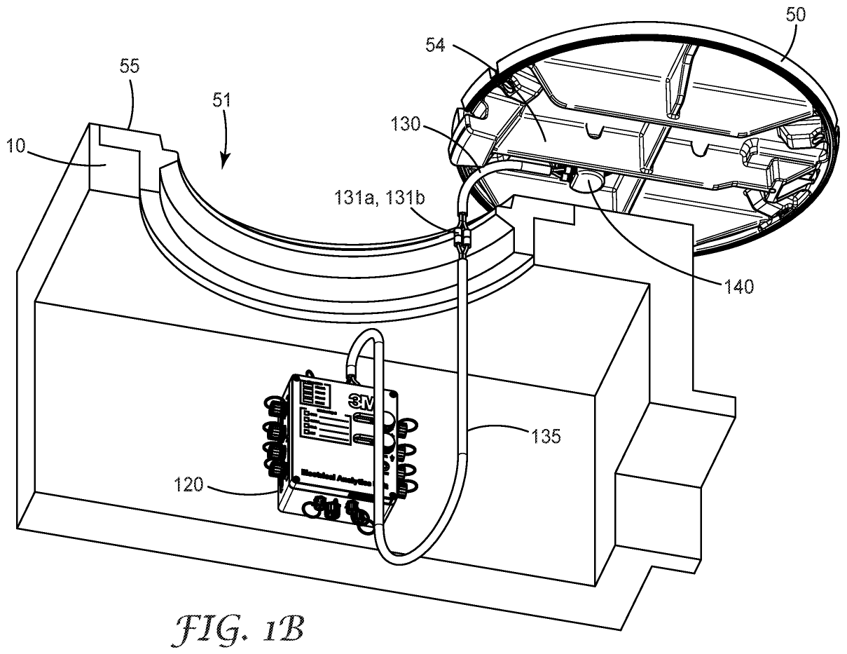

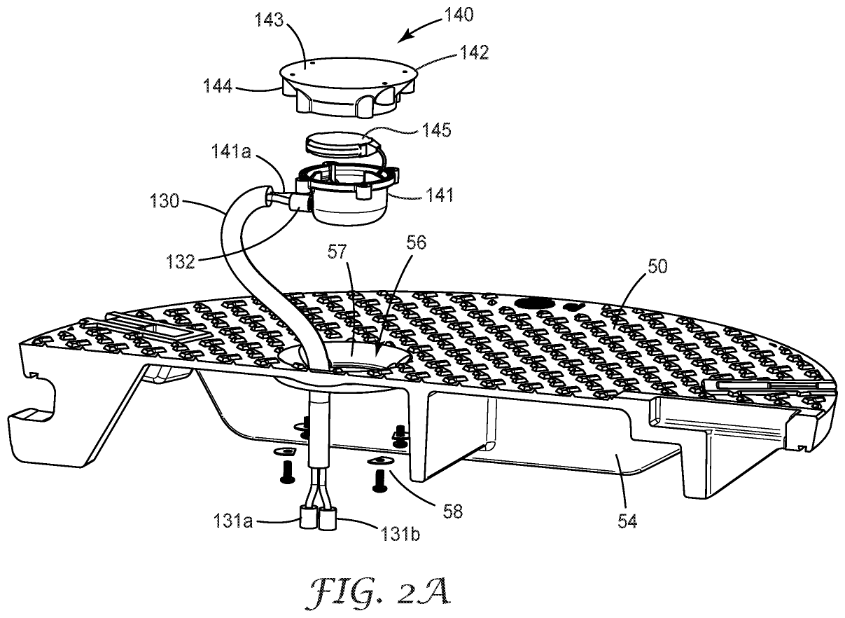

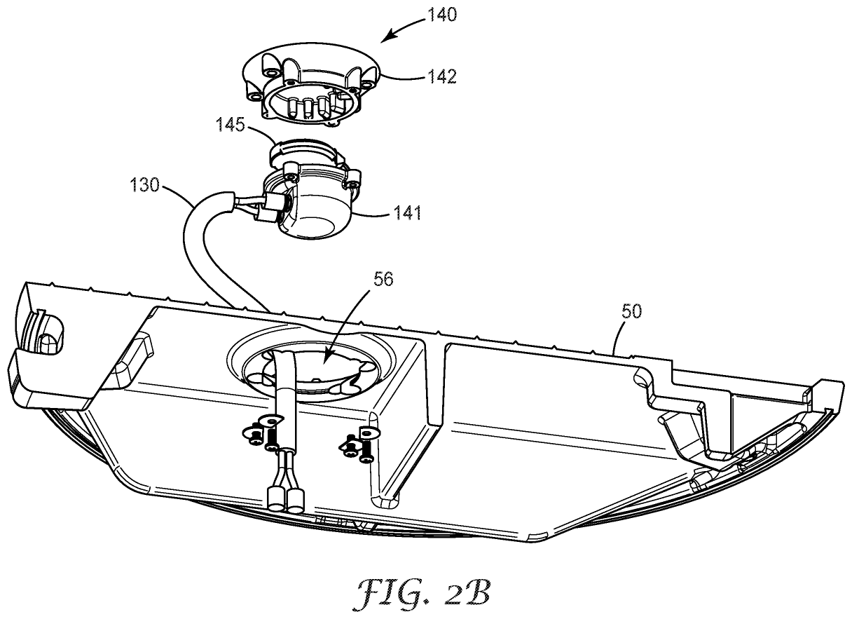

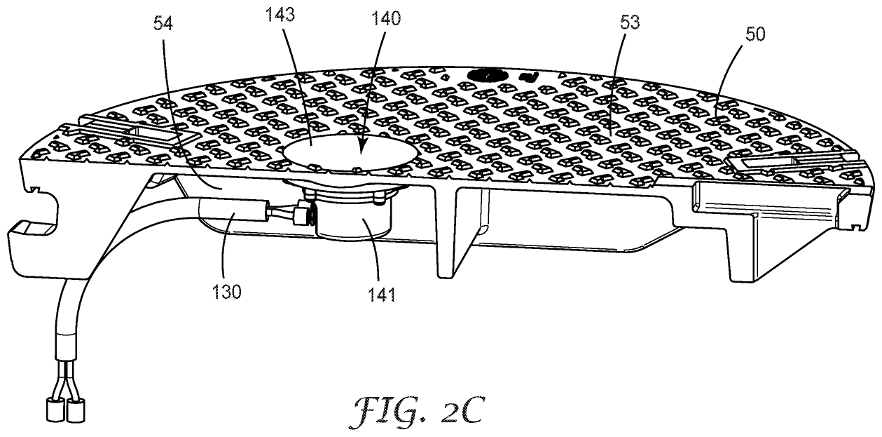

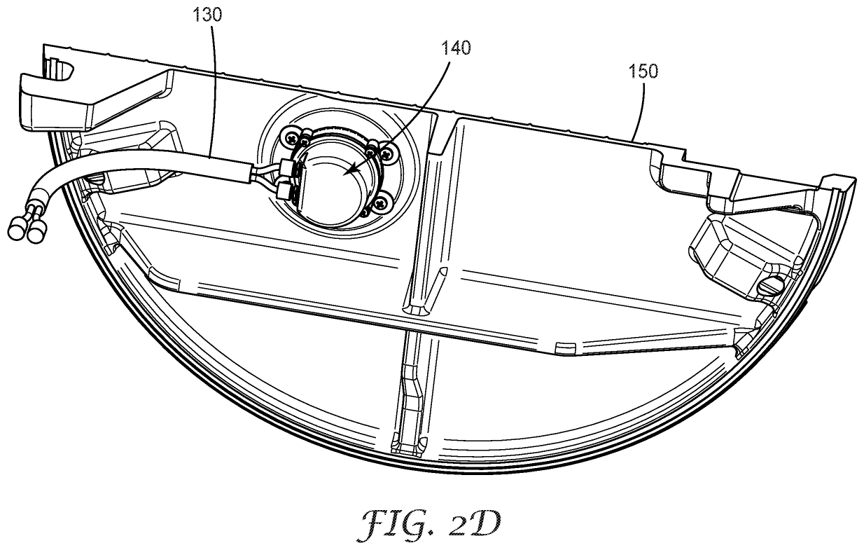

FIGS. 1A-1B show one aspect of the present invention, a transceiver 140 that is part of a data communication system 100. In this aspect, the data communication system 100 is an underground data communication system. FIGS. 2A-2D show different views of the transceiver mounting process.

In one aspect, a data communication system 100 can provide a communication infrastructure to relay enclosure/vault condition information to an above ground network or SCADA. As shown in FIGS. 1A and 1B, the data communication system 100 comprises a transceiver 140 configured to communicate with a network outside of the enclosure. In one aspect, the transceiver 140 is mountable to a manhole cover 50. As shown in the exploded view of FIG. 2A, the transceiver housing can include a cover or top portion 142 and a bottom portion 141. As shown in FIG. 2A, the transceiver 140 includes an antenna 145 which communicates with widely available above-ground wireless communications networks such as WiFi, WiMax, mobile telephone (3G, 4G, LTE, GSM), private licensed bands, non-licensed bands, etc.

Transceiver antenna 145 can further include a GPS antenna (module) to communicate position information to a utility network, SCADA or technician. The transceiver antenna can be utilized as a passive or active antenna. The transceiver housing 141, 142 can have a shape and size configured to tightly fit within an opening 56 formed in the manhole cover.

While a communications radio is generally located in the SAU 120, in an alternative embodiment, the transceiver 140 can optionally include a radio.

In one aspect, the top surface 143 of the transceiver 140 may be substantially flush with the top surface 53 of the manhole cover 50, such as is illustrated in FIG. 2C.

Optionally, the transceiver 140 can also include a micro controller or microprocessor (not shown) to control transceiver communication operations, content and timing.

The transceiver housing 141, 142 can be a sealed structure and may include one or more housing parts such as a cover 142 and base portion 141. At least some of the housing parts may be made of a moldable plastic material, or suitable thermoplastic or elastomeric material, and can be optionally reinforced with fiberglass. The material of the housing parts may be resistant to aggressive substances. The housing can be sealed, e.g., meeting IP68 requirements, to protect the radio, antenna, and/or other components contained within it. By using a seal of appropriate material, such as a graphite-containing material, a seal may additionally be provided against aggressive substances like gasoline or oil which may be present in an outside environment. In another aspect, for example, the housing can comprise a polycarbonate material with a polyurethane core, with a ribbed area that provides flexibility to keep the polycarbonate material from cracking.

As shown in FIG. 2A, transceiver housing cover 142 can include a tapered side wall 144 that is tapered at an angle (e.g., 20° to 70°) corresponding to the taper angle of side surface 57 of entrance port opening 56. With this design, the transceiver housing can be installed by lowering the transceiver into the entrance port opening 56 until surface 143 is substantially flush with entrance port cover top surface 53. Mounting screws or fasteners 58 can be employed to secure the transceiver 140 in place within entrance port cover 50.

Further, the transceiver housing base portion 141 can include a flattened side portion 141a, or side outlet, where connector 132 is coupled to the transceiver. When shown in the installed state, such as in FIG. 1A, the cable 130 is directed parallel to a lower surface of the entrance port cover 50, and along a lower support rib 54, thus providing an added degree of protection for the cable 130 against damage, where rib(s) 54 extend towards the outer edges of the manhole cover 50. In this aspect, cable 130 can include a protective cover configured to protect against water and impact damage.

In addition, as shown in FIGS. 1A and 1B, the data communication system 100 can also include a sensor analytics unit (SAU) 120 (also referred to as an electrical analytics unit), which is mounted in the enclosure or vault 10. In this aspect, a cable 135, such as a tethered or non-tethered cable, can connect the transceiver 140 with the sensor analytics unit 120 via copper and/or fiber cabling, such as a RF cable (e.g., a LMR240 cable). Cable 135 can be further connected to cable 130 via a breakaway connector 131a, 131b (see e.g., FIG. 2A), such as a conventional mechanical (e.g., snap fit) or magnetic connector or coupling, which is configured to break a connection when the pulling force reaches a modest level, thus protecting the connector 132, the transceiver 140, and/or SAU 120 from damage if the entrance port cover 50 is displaced a great distance from the entrance port 51. The SAU 120 can be connected to one or more sensors (not shown) or other equipment located in enclosure/vault 10.

In another aspect, cable 130 and cable 135 can be combined as a single cable, without a breakaway connector.

In an alternative aspect of the invention, the transceiver 140 can be a fully integrated transceiver that can also include a power source (such as a battery or supercapacitors) to power the transceiver 140 on an at least an intermittent or emergency basis.

In one aspect of the invention, data communication system 100 is disposed in an exemplary underground enclosure, here underground vault 10. In this example implementation, vault 10 can include a variety of equipment, such as one or more high voltage electrical lines, such as electrical lines (carrying e.g., low, medium or high voltage power), and associated components and/or accessories, such as a power harvester, and associated cables. The vault can contain additional equipment, such as is described in U.S. Pat. No. 9,961,418, incorporated by reference herein in its entirety.

A monitoring device can be configured as a sensor disposed on a cable accessory, such as a termination, electrical equipment or components thereof, or on a cable or electrical/power line. Such a sensor can provide sensing capabilities that measure a cable condition, such as voltage, current, and/or temperature. An exemplary sensored termination is described in U.S. Pat. No. 9,742,180, incorporated by reference herein in its entirety.

The enclosure or vault 10 can be accessed from above ground via a portal or entrance port 51 that includes a manhole cover 50, which can be formed from a metal or non-metal, and can have a conventional circular shape. In one aspect, the manhole cover 50 can be mounted on a ring, frame or flange structure 55 of the entrance port 51. In one aspect, the manhole cover 50 can comprise a conventional manhole cover. In another embodiment, the manhole cover 50 can comprise an explosion mitigation cover, such as is available from Neenah Foundry and EJ USA, Inc. An exemplary manhole cover is described in U.S. Pat. No. 8,784,000.

In this aspect, vault 10 is can be constructed as a conventional underground vault, commonly used by electric, gas, water, and/or other utilities. However, in alternative aspects, the underground data communication system 100 can be utilized in another type of underground enclosure or similar structure, such as a manhole, basement, cellar, pit, shelter, pipe, or other underground enclosure.

The SAU 120 can be mounted at a central location within the vault 10, or along a wall or other internal vault structure. The SAU 120 can include a digital signal processor (DSP) or system on a chip (SOC) to receive, manipulate, analyze, process, or otherwise transform such data signals into signals useable in a supervisory control and data acquisition (SCADA) system. In addition, the DSP can perform some operations independently of the SCADA. For example, the DSP can perform fault detection, isolation, location and condition monitoring and reporting. Moreover, the DSP/SAU can be programmed to provide additional features, such as Volt, VAR optimization, phasor measurement (synchnophaser), incipient fault detection, load characterization, post mortem event analysis, signature waveform identification and event capture, self-healing and optimization, energy auditing, partial discharge, harmonics/sub-harmonics analysis, flicker analysis and leakage current analysis. In another aspect, the SAU 120 can further include a communications radio, such as when transceiver 140 comprises a passive antenna only.

The SAU 120 can perform local analysis and interpretation of data from the sensors and communicate that analyzed data, via a radio disposed therein, to the antenna of the transceiver 140. The SAU 120 includes an integrated GPS circuit or chip to generate GPS location signals to a GPS antenna located in the transceiver antenna unit 145. The integration of GPS capabilities along with time synch events leads to finding key problems with early detection with set thresholds and algorithms for a variety of incipient applications/faults/degradation of key structural or utility components.

In addition, the DSP and other chips utilized in the SAU 120 can be configured to require only low power levels, on the order of less than 10 W. In this aspect, SAU 120 can be provided power via a power harvesting coil that can be coupled to one of the electrical lines to provide sufficient power to the SAU 120.

In addition, the SAU 120 can be implemented with a capacitor bank or a backup battery (not shown). Further, the SAU 120 can include additional sensors to monitor, e.g., environmental conditions within the enclosure.

The processed data from the SAU 120 can be communicated to an external network or SCADA via a transceiver 140.

In one aspect of the invention, the vault 10 can also include at least one monitoring device or sensor disposed therein which can monitor a physical condition of the vault or of the components or equipment located in the vault. Such conditions would normally be difficult to gather or assess from above-ground. The monitoring device can comprise one or more of the following sensors: power, voltage, current, temperature, combustible materials or byproducts of combustion, mechanical strain, mechanical movement (e.g. revolutions per minute), humidity, soil condition (acidity, moisture content, mineral content), pressure, hazardous atmosphere, liquid flow, leakage, component end-of-life or lifetime (e.g., a cathodic protection sensor), personnel presence (e.g., has someone entered the enclosure), physical state (e.g., is the enclosure open or closed, is a switch or valve open or closed, has an item been tampered with), light sensor, vibration (seismic, tampering).

The present invention has now been described with reference to several individual embodiments. The foregoing detailed description has been given for clarity of understanding only. No unnecessary limitations are to be understood or taken from it. All references to right, left, front, rear, up and down as well as references to directions are exemplary only and do not limit the claimed invention. It will be apparent to those persons skilled in the art that many changes can be made in the embodiments described without departing from the scope of the invention. Thus, the scope of the present invention should not be limited to the details and structures described herein, but rather by the structures described by the language of the claims, and the equivalents of those structures.

1. A data communication system for an enclosure, comprising:
a transceiver mountable to a mounting location formed in an entrance port cover for the enclosure, the transceiver connectable to a sensor analytics unit disposed within the enclosure, the transceiver including a housing having a cover portion with tapered sidewalls receivable in the mounting location, wherein the mounting location includes a hole having correspondingly tapered sidewalls, wherein a top surface of the transceiver is configured to be positioned substantially flush to an upper surface of the entrance port cover when the transceiver is placed in an installed position, and wherein the transceiver includes an antenna configured to communicate with a network outside of the enclosure.

2. The data communication system of claim 1, wherein the sensor analytics unit processes data from a sensor disposed in the enclosure, generates a processed data signal, and communicates the processed data signal to the transceiver.

3. The data communication system of claim 1, wherein the transceiver is installable on the entrance port cover in a top-down manner.

4. The data communication system of claim 1, further comprising:
a cable connecting the sensor analytics unit to the transceiver via a breakaway connector configured to detach under a modest pulling force.

5. The data communication system of claim 4, wherein, when the transceiver is placed in an installed position, the cable is directed parallel to a lower surface of the entrance port cover, and along a lower support rib of the entrance port cover.

6. The data communication system of claim 1, wherein the transceiver cover portion is formed from a material transmissive to radio waves.

7. The data communication system of claim 1, wherein the enclosure comprises an underground vault.

8. The data communication system of claim 1, wherein the transceiver housing includes a base portion having a side outlet, where a connector is coupled to the transceiver.

9. The data communication system of claim 1, wherein the transceiver includes a radio antenna and a GPS antenna.

10. The data communication system of claim 1, wherein the transceiver housing is sealed to meet IP68 requirements.

11. The data communication system of claim 1, wherein the transceiver includes a passive antenna.

12. The data communication system of claim 1, wherein the transceiver includes an active antenna.

13. A method of installing a transceiver of a data communication systems into an entrance port cover of an enclosure, comprising:
inserting, in a top down manner, a transceiver having a housing including a cover portion with tapered sidewalls in a mounting location formed in the entrance port cover, wherein the mounting location includes a hole having correspondingly tapered sidewalls, wherein a top surface of the transceiver is configured to be positioned flush to an upper surface of the entrance port cover when the transceiver is placed in an installed position.
